(19) United States
(12) Patent Application Publication
(10) Pub. No.: US 2018/0129181 A1
(43) Pub. Date: May 10, 2018

(54) Chatbot Systems and Methods for Industrial Machinery

(71) Applicant: BioHiTech America, LLC, Chestnut Ridge, NY (US)

(72) Inventors: William M. Kratzer, III, Harrisburg, PA (US); Ryan C. Bohn, Elizabethtown, PA (US); Frank E. Celli, Montvale, NJ (US); Robert A. Joyce, Mechanicsburg, PA (US)

(21) Appl. No.: 15/678,336

(22) Filed: Aug. 16, 2017

Related U.S. Application Data
(60) Provisional application No. 62/376,166, filed on Aug. 17, 2016.

(51) Int. Cl. G05B 19/05; H04L 12/58; G06F 17/27

(52) U.S. Cl. CPC G05B 19/05; H04L 51/02; H04L 67/10; G06F 17/2705; G06F 17/2785

(57) ABSTRACT

Systems and methods for remotely communicating with and controlling industrial machinery. At least one piece of industrial machinery has at least one sensor for monitoring at least one condition of the piece of industrial machinery; and a programmable logic controller (PLC) directly controlling operation of the piece of industrial machinery and in communication with the sensor. A local computer is in communication with the PLC adapted to query and write data from and to the PLC. A remotely accessible chatbot interface is provided in communication with the local computer, adapted to enable natural language interaction between a user and the piece of industrial machinery. A user accesses the chatbot interface on a remote device adapted to communicate with the local computer.

### RELATED APPLICATIONS

Priority is claimed from U.S. Provisional Patent Application No. 62/376,166 filed Aug. 17, 2016 entitled “A Chatbot System for Industrial Machinery”, the entirety of which is incorporated by reference herein.

### BACKGROUND OF THE INVENTION

### Field of the Invention

The invention is generally directed to systems and methods for monitoring and controlling equipment such as industrial machinery, and to interactive communication technology that enables users to communicate with industrial equipment in real time. More specifically, the invention is directed to systems and methods for enabling the remote monitoring and control of industrial equipment typically having a programmable logic controller (PLC) via a natural language interface such as a chatbot.

### Description of Related Art

It is desirable to be able to monitor industrial equipment remotely that may require periodic preventive maintenance and/or that may require rapid response time should a catastrophic failure occur. One type of such equipment is a food waste disposal system. Food waste disposal systems may be used to replace conventional waste disposal means, e.g., haulage of food waste to landfills, which is costly, inefficient, and possibly harmful to the environment. A typical waste disposal machine is embedded with a PLC. The PLC is pre-programmed with a very simple array of tasks. While it is better to use a typical waste disposal machine in this limited manner, this conventional method has its drawbacks, chief among them the limitations of PLCs currently used in industrial equipment. PLCs are memory constrained. PLCs are typically unable to be remotely updated over the Internet. (PLCs are typically not even connected to the Internet.) Moreover, PLCs are not programmed to pull data over the Internet to make software decisions concerning ways to operate the associated machinery in a more efficient manner that will serve its task faster and/or less expensively.

Additionally, the components of a food waste disposal system, a building's HVAC system, or the like, must be monitored or checked frequently. Preventive maintenance must be performed on a constant basis, particularly with larger systems. Fault or failure conditions may vary in degrees of severity, however the contractor responsible for maintaining the equipment should be made aware of each failure as well as non-failure operational parameters in due course. Since a contractor, in all likelihood, is responsible for the care and maintenance of the installations of multiple clients, and since fault conditions may occur at any time of day or night, it is not practical for a contractor to remain on-site all the time. Remote detection of fault conditions is desirable and often crucial.

Some basic remote monitoring devices have been developed. U.S. Pat. No. 5,629,687 to Sutton et al. describes a universal interface for remotely-monitored security or alarm systems. In Sutton et al., a local control unit at a monitored site can, under an event condition, initiate a telephone call to a central control unit to alert a human operator of an event such as an intrusion, fire, or other emergency at the site. The local control unit, via the telephone link, sends a serial number indicative of the specific site and emergency to the monitoring center computer. The monitoring center computer receives the serial number and alerts a human operator as to the emergency. The human operator can then act accordingly, e.g., establish one- or two-way communication with the local site.

U.S. Pat. No. 5,748,104 to Argyroudis et al. describes a wireless remote telemetry system which provides real-time reading and remote control of devices such as electricity meters. A home base unit communicates with remote metering units via cellular telephone lines. The home base unit also communicates with a central controller operated by the electric utility. When the utility determines that there is too much load on the power grid, for example, the central controller can send messages to an appliance to turn off. A customer could also remotely activate or deactivate an appliance via a cellular phone through the home base unit.

U.S. Pat. No. 5,061,916 to French et al. describes a system for remotely reporting, in graphical format, alarms or other conditions in a building's automation system. Sensors in a building are hooked up via a telephone line to control module which is, in turn, hooked up to a central controller. When a sensor detects a fault condition, graphical information is compiled at the central controller and transmitted to one or more remote facsimile machines.

However, all of the above systems are limited because they provide simple outgoing messages to the user. It is desirable to be able to query a device affirmatively whenever desired, not simply for the purposes of avoiding catastrophic failure of the device, but also to be able monitor how well or efficiently the device is doing its job, alter how a device functions to have it function better/more efficiently, among other reasons.

Historically, this may have been performed by going to the location of the machine, using a touchscreen interface to see the current state of the machine, and navigating a complex user interface on the machine to change the machine from one mode to another.

Accordingly, there is a long-felt need to enable a user to interact with (e.g., check status, modify operation, etc.) industrial machinery, especially industrial machinery using a PLC, remotely.

There is also a long-felt need to enable a user to interact with industrial machinery in a very easy to understand manner that does not require a lot of training for the user to operate the machine interface.

### SUMMARY OF THE INVENTION

The invention is a chatbot system for use with industrial equipment. A chatbot is a piece of software that simulates conversation with a human, over the Internet. Industrial equipment, in this invention, includes any piece of machinery with an embedded electronic control system or PLC. The chatbot system described in this document allows people to use text messaging or voice input to have a natural language-based conversation to query, control, or manage a piece of industrial equipment.

The chatbot system allows users to use text messaging or voice input to have a conversation with a piece of industrial equipment. The user can use this conversational messaging to query the industrial machinery for information about its current state, get historical data, troubleshoot operational issues, and control the equipment itself.

The implementation of the system outlined in this document allows industrial machinery to be a smart machine that can assist the user in diagnosing problems, provide useful information, and allows control capabilities straight from a user's mobile or web device using a natural language-like interface which required minimal training.

The chatbot system primarily exists on server-based environment (referred to herein as “The Cloud”). The chatbot system also has technology components that reside close to the industrial machinery as well as technology that may exist near the user (such as a mobile application, a chat client, or a web application).

In one aspect of the invention, the invention includes a system for remotely communicating with and controlling industrial machinery. At least one piece of industrial machinery is provided. The piece of industrial machinery includes at least one sensor for monitoring at least one condition of the piece of industrial machinery and a programmable logic controller (PLC) directly controlling operation of the piece of industrial machinery and in communication with the sensor. A local computer is provided in communication with the PLC adapted to query and write data from and to the PLC. A remotely accessible chatbot interface is in communication with the local computer, adapted to enable natural language interaction between a user and the piece of industrial machinery. A user accesses the chatbot interface on a remote device adapted to communicate with the local computer. Preferably, at least a portion of the chatbot interface resides in a cloud computing environment. The chatbot interface preferably includes a user interface, accessible from the remote device, adapted to receive and send natural language messages to and from a user; and a chatbot gateway that authenticates incoming messages from the user.

In another aspect of the invention, the invention includes a method of remotely communicating with and controlling industrial machinery via a chatbot interface. A text-based message is sent via a messaging application to a chatbot gateway. The text request is sent from the chatbot gateway to a natural language processing system. The semantic structure of the incoming request is deconstructed at the natural language processing system. The semantic structure is parsed and mapped against a library of commands and queries. A command or query that correlates to the parsed and mapped incoming request is sent to a local computer via a persistent network connection. Logic is executed at the local computer to read or write data to the industrial equipment's PLC. The logic executing step optionally causes a command to be issued to the industrial machinery. Once the command is completed, data is sent back to the user from the local computer via the chatbot gateway to the user in their messaging application. The chatbot gateway and the natural language processing system are preferably cloud-based. Preferably, the messaging application is accessible by the user from a remote device.

A system such as this has numerous advantages. First, it is easy to use. Many people are familiar with how to use instant messaging and chat-based software. This level of convenience allows the user to interact with the industrial equipment without installing specialized software on their computer or mobile smart phone. Additionally, the natural conversational tone of the chatbot system allows the system to query and instruct the equipment using natural language, which may be much simpler to use than a complex monitoring software package or cryptic touch display system. This type of system minimizes training and minimizes installation of new software.

Second, the invention enables remote usage. The chatbot system allows users to access the industrial equipment at the comfort at their desk or using the convenience of their smart phone. This remote query and management ability allows the user to access the machinery from anywhere.

Third, the invention provides improved visibility. The artificial intelligence, machine learning, and rules-based execution engines can help guide the conversation with the end-user to allow the user to diagnose and correct problems faster, and deliver more relevant information sooner.

Fourth, the invention provides greater transparency. The system transparency gathers and reports data about a machine, regardless of where the data is located. For example, real-time status information about the machine may come from the industrial equipment itself. Historical data or planned maintenance activity may come from another database in the “Cloud”. However, the user isn't required to think about where the data comes from. As far as the user is concerned, they are just having a conversation with a “Smart Machine” that knows the answers to all of these questions.

Fifth, the invention provides security. Security for this entire system is managed server-side, in The Cloud. Server-side computing has much larger computing capacity than what may be available near the industrial equipment. This allows for the chatbot system to enforce a more complex security layer than what may be traditionally available, onsite at the equipment itself. For example, server-side can implement roles-based security and different levels of security to different machines. More sophisticated authentication mechanisms (such as multi-factor authentication) can be more easily implemented in the Cloud. Finally, all Cloud-based authentication and authorization can be instantly changed and enforced in real-time, something which is difficult to implement in widely geographically dispersed clusters of industrial machinery.

Additionally, the invention allows for/facilitates auditing. Because the entire system is managed in the Cloud, a complete set of audits can be recorded and presented to administrators of the system. This includes the ability to view any data requests, or any configuration changes made to the machine or any control operations requested by the user of the machine.

Moreover, there is less training required. The natural conversational tone of the chatbot system allows the user to query and instruct the machine to perform very complex tasks that traditionally would only be available using complex software displayed on the HMI (Human Machine Interface) panel of the machine. This ease of use minimizes training and minimizes installation of new software.

There is also significant ease of installation achieved by the invention. While there are remote-access solutions today for industrial equipment, this software tends to be expensive, difficult to install and configure, requires custom software on every computer where remote access is desirable. The invention requires no special software installed by the end-user. The end-user can simply use their messaging platform of choice (many of which may come press-installed on their mobile devices or computers).

Also, the solution outlined herein can also be easily retrofitted onto existing equipment with minimal investment or disruption of operations. Since most of the components of the invention run inside a computing cloud, little change needs to occur inside of the industrial equipment itself. The introduction of an internet-enabled local computer is the only new piece of physical equipment that need be introduced onsite.

### BRIEF DESCRIPTION OF THE DRAWINGS

FIG. 1 is a block diagram schematic overview of a chatbot system for controlling and communicating with industrial machinery in accordance with the invention.

FIG. 2 is a block diagram flow chart illustrating the overall flow of a communication between a user and a piece of industrial machinery within a chatbot system for controlling and communicating with industrial machinery in accordance with the invention.

FIG. 3 is a block diagram schematic overview of the chatbot portion of a chatbot system for controlling and communicating with industrial machinery in accordance with the invention.

FIG. 4 is a schematic illustration of a first “conversation” between a user and a chatbot as seen by the user in accordance with the invention.

FIG. 5 is a schematic illustration of a second “conversation” between a user and a chatbot as seen by the user in accordance with the invention.

FIG. 6 is a schematic illustration of a third “conversation” between a user and a chatbot as seen by the user in accordance with the invention.

FIG. 7 is a block diagram of an exemplary computing environment within which various embodiments of the invention may be implemented.

### DETAILED DESCRIPTION OF THE INVENTION AND DRAWINGS

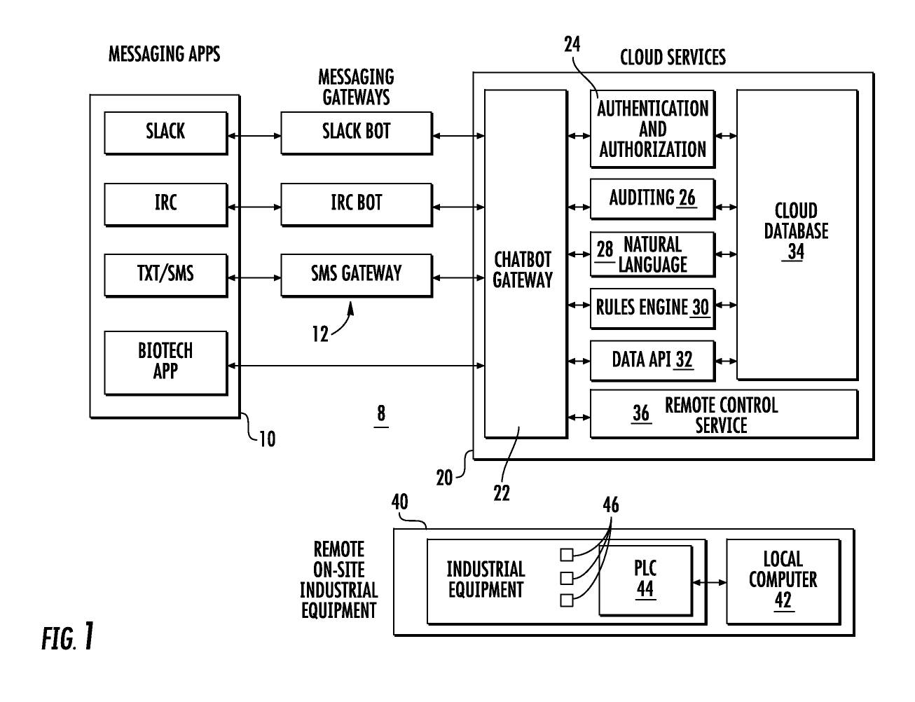

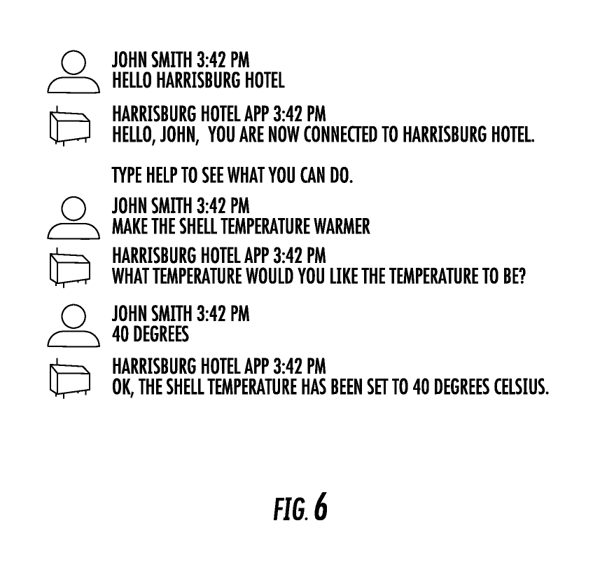

Description will now be given with reference to the attached FIGS. 1-7. It should be understood that these figures are exemplary in nature and in no way serve to limit the scope of the invention, which is defined by the claims appearing hereinbelow.

FIG. 1 is an overview of an embodiment of a chatbot system for controlling and communicating with industrial machinery in accordance with the invention. The following system components make up the chatbot system 8 of the instant invention.

Chat Application or User Interface 10 is the user interface to a computer application on a computer (desktop, laptop, mobile device, watch) where the end-user converses with people or machines. This could be a standard messaging application that is built into many computer systems and smartphones, or it could be a third-party commercial software application. Interface 10 enables the user to communicate with and/or control industrial equipment 40 remotely, from any location, via a variety of Cloud Services 20 (described below).

Chatbot Integration 12. Many third-party chat applications provide a formal “chatbot integration” which is a small piece of software that can be installed into an existing chat application used by the user. This software will intercept chat messages sent to certain “channels” or “users” and forward them to a 3rd party for processing. In this case, the messages go to the Chatbot Gateway 22 (see below). Not all messaging applications need to use Chatbot Integration 12. Custom mobile applications can talk directly to the Chatbot Gateway 22 as well.

Much of the functionality of chatbot system 8 resides in Cloud Services 20. Each of the following subsystems/modules may reside on one or more actual machines, depending on the specific deployment of the system. In any event, it is preferred to have these subsystems/modules cloud-based so that there are minimal computing and data demands made on either the user's device where User interface 10 resides or local computer 42.

The Chatbot Gateway 22 is the interface between the Chat Application 10 (or Chatbot Integration 12) used by the user, all of the cloud-based components listed below, and the industrial equipment 40. The Chatbot Gateway 22 uses features in the cloud to authenticate, authorize, parse, and audit the incoming requests. Additionally, it may pull data from a Cloud Database 34 or a Rules Engine 30 or communicate in real-time to the industrial machinery 40.

Authentication and authorization system 24. The Chatbot Gateway 22 queries the authentication and authorization system 24 to ensure that the request is authorized for the appropriate piece of equipment. Chat users are mapped to Cloud system users, and cloud system users are mapped to roles and machines to which users have access. The roles further denote the level of access that the user has to the system.

Auditing Layer 26. The Chatbot Gateway 22 sends all requests to an auditing layer 26 that will log and track all systems changes made to machines as well as a general log of all requests and commands sent to machines.

Natural Language Processing System 28. The Chatbot Gateway 22 communicates with a natural language processing layer 28 (also referred to as a conversation engine below) to deconstruct the grammar and intent of the incoming request.

Rules & Workflow Engine 30. The Chatbot Gateway 22 communicates with a rules engine 30 if the user initiates a workflow that involves one matched via the Rules & Workflow Engine 30. The Rules & Workflow Engine 30 will typically walk a user through a sequence of steps to troubleshoot an issue with the industrial machine 40 or to execute a complex task. The Rules & Workflow Engine 30 will tell the Chatbot Gateway 22 what information, text, and choices to present next to the user.

Cloud Data API 32. If the incoming request can be answered by the centralized cloud database, then the Chatbot Gateway sends a request to a centralized Cloud Data API 32 (Application Programming Interface) to pull data. This may be useful for things like getting information on upcoming service visits, historical usage, and other types of data that are typically calculated and stored on The Cloud.

Remote Control Service 36. If a request is for live data stored directly by the Industrial Machine 40, the Chatbot Gateway 22 sends a request to a centralized Remote Control Service 36 where specific data commands and queries can be sent to individual machines in real-time.

Local computer 42. Local computer 42 is connected in proximity to the industrial machinery 40 and in communication with the machinery's PLC 44, which in turn is in communication with machinery sensors 46. (Alternatively, local computer 42 can be in direct communication with one or more sensors 46.) Local computer 42 queries and writes data from and to the industrial machinery's PLC. This data is routinely reported up to the cloud (over a secure channel) for data reporting and collection. Additionally, a long-lived data connection is maintained by local computer 42 to the Cloud Remove Control Service 36 so that it can receive data commands from the Remote Control Service 36. Local computer 42 understands the details of talking to different types of industrial equipment.

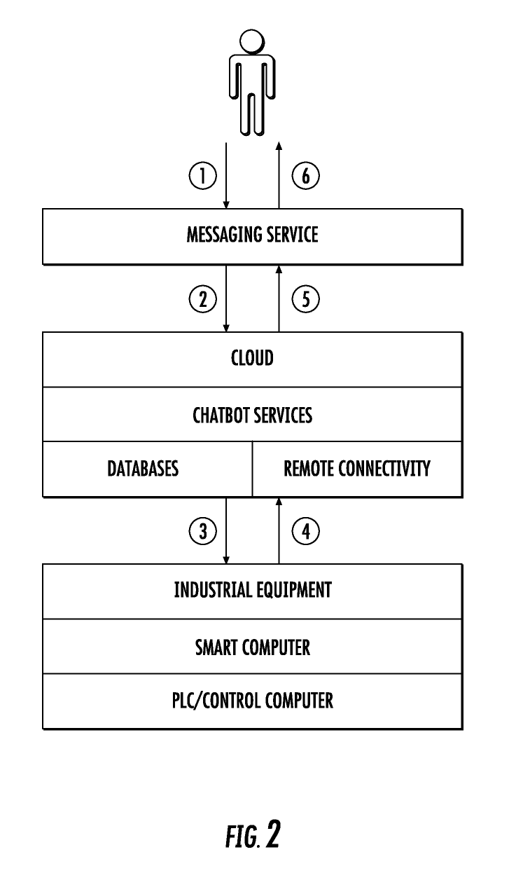

A high level overview of a typical message flow is depicted in FIG. 2. In step 1, the user sends a text/chat message to the chatbot using a chat or messaging application 10. The Cloud 20 receives the message in step 2. The chatbot services parse and process the request. If the request requires real-time data or real-time operation of the industrial equipment, then the logic flows to step 3. If all the data can be retrieved from the cloud, then the logic flows to step 5. In step 3, cloud services 20 uses a secure connection to the industrial equipment 40 to send a request to the local computer 42, which is co-located with the industrial equipment's PLC 44. In step 4, local computer 42 processes the request by communicating with the Industrial Equipment's PLC to control the machine or retrieve data from the machine and/or retrieve data directly from sensor(s) 46. The response data is sent back to the Cloud 20. In step 5, all the data from the chatbot request is retrieved from the required data sources (either in the cloud and/or the industrial equipment). A response is generated and sent back to the user. The user receives a reply from the system in their messaging application in step 6.

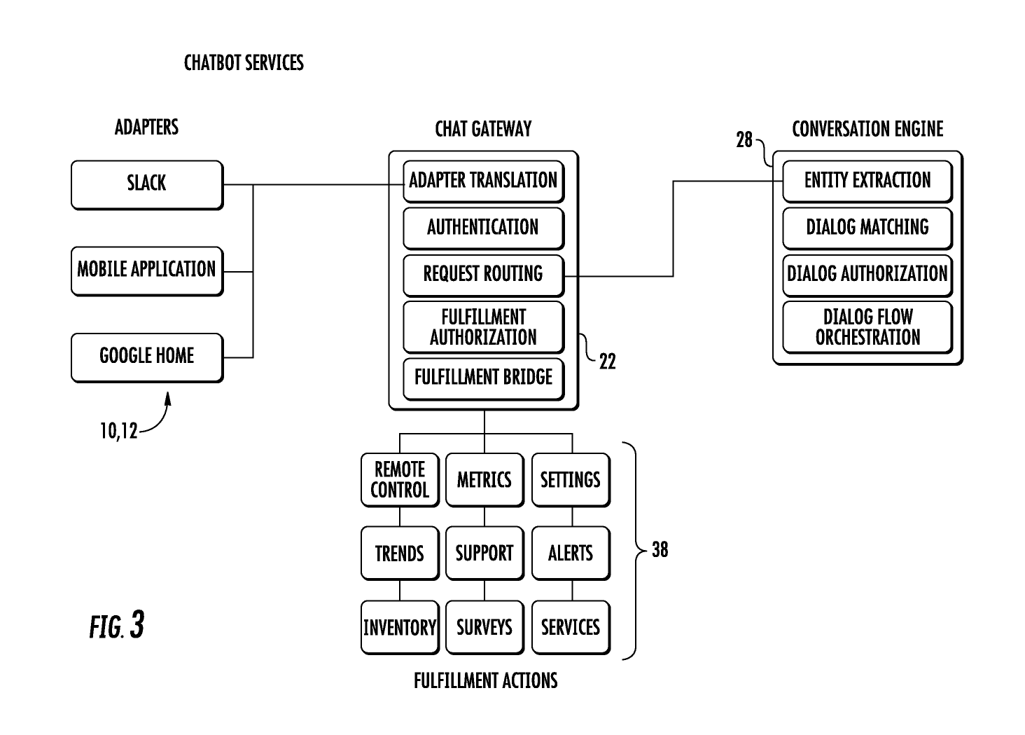

A more specific view of the structure of the chatbot system appears in FIG. 3.

A. Adapters

Adapters are pieces of software that integrate with different messaging systems and can route messages to the cloud. Examples of messaging adapters include (but are not limited to): SMS adapters—process messages from a third-party SMS (Short Message Service); Slack—a popular, third-party chat-application which contains customizable extensions; Google Home—a popular voice-appliance; Custom web-based chat application.

B. Chat Gateway

The Chat Gateway 22 is a collection of services that are responsible for orchestrating messages from incoming messaging applications, the Conversation Engine 28 (which handles message parsing and understanding), and the processing actions.

The chat engine consists of the following key components.

Adapter Translation. The adapter translation layer is the glue between the messaging services and the rest of the system. This layer performs three key activities. The first is to request message conversion. It converts the incoming messaging into a common messaging format for the rest of the system. The second is message mapping: it maps the incoming request to a specific user in the system. This is required for authentication and authorization services. For example, when processing SMS messages, the incoming mobile phone number of the user may be used to map the incoming message to a user's known mobile phone number. The third is response message conversion: it converts a response message into the specific text or voice message for targeted messaging system.

Authentication. After the message has been translated, an authentication process can take place. If a user is using a secure messaging application registered to the Cloud and the user itself is registered to the Cloud, then the authentication may be successful. The system may optionally reply with an authentication challenge (asking the user to provide a password, click a link on an email, or conduct any other type of common security challenge).

Request Routing—The message is routed to Conversation Engine 28, where further analysis is done on the message.

Fulfillment Authorization—Once the intent of the message has been finalized by Conversation Engine 28, a series of “fulfillment actions” 38 may take place. The system can instantly ensure that the requesting user has the authority to perform those fulfillment actions.

Fulfillment Bridge—maps a request to the individual services that may be required to process the request. For example, this may be a request for data or an action on the remote piece of equipment or it may be a request for data from the cloud database.

C. Conversation Engine

The next main section of the system is the Conversation Engine. The Conversation Engine handles the parsing of the incoming message, extracting the meaning of that message, and helps inject that message into the context of an existing conversation if one exists, or creates a new conversational context if one does not exist.

In the Entity Extraction module, the incoming message is parsed, pulling meaningful information out of the message for potential use as parameters for fulfillment actions (used later in the processing).

At the Dialog Matching module, using classical natural language processing and document classification techniques, the incoming text is matched to a series of dialogs in the system. Dialogs in this system represent a workflow or a part of a conversation. For example: a “greeting dialog” may be used to represent a connection to a new piece of equipment, and is typically represented by requests such as “hello {machine name}” or “hey {machine name}” or “connect to {machine name}”. As another example: a “smell dialog” may be used to represent a multi-part conversation regarding the fact that an odor is coming from the machine, and may be represented by requests/message such as “it stinks”, “the machine smells”, “I smell something bad”, “there's an odor”, etc.

The Dialog Authorization module enables the system to instantly check whether the user is authorized to process the matched Dialog(s). For example: everyone may be able to say hello to a machine to connect to one, but only certain users may be able to change the water usage parameters of a machine (typically, this may be limited to a small number of users).

The Dialog Flow Orchestration module defines the possible interactions between the user and the system based on the current context of the conversation. Dialogs also understand required parameters and prior conditions or actions that need to have been performed. Based on the information passed into the request (and based on prior parts of the conversation), this system may instruct the chatbot gateway to process the request directly in the fulfillment system, or the system may instruct the chatbot gateway to ask for more information based on the requirements of the workflow.

D. Fulfillment Actions

The last main conceptual piece of the system is fulfillment actions 38. Fulfillment actions 38 are a library of software actions that can be acted upon by the Chatbot system and include, as shown in FIG. 3, remote control, metrics, settings, trends, support, alerts, inventory, surveys, and services. This list is not meant to be exclusive. These actions may involve actively reading from or writing to databases from the cloud-based system. Examples of such action may include the following:

Access to analytics data about the machine's performance. This data is typically so large that it may be stored in online servers and databases in the Cloud.
Access to metadata or operational data that typically does not reside on the machine, including: service history, upcoming service visits, service manuals, equipment serial numbers, warranty information, etc. These actions may also involve remotely connecting to the remote industrial equipment to perform a request on the PLC of that equipment.
Access to sensor data, such as (but not limited to) temperature sensors, load cell information, door sensors, water meters, etc.
Access to operational data, such as (but not limited to) the operational state of the machine: conveyor belt status, water usage, pump operation, etc.
Access to configuration data, such as (but not limited to): recipes, timings, calibration, cycles, etc.

E. Regarding Remote Connectivity to Equipment

An important piece of this invention is connectivity to remote industrial equipment. Since the messaging systems and the Cloud are accessible and work over the Internet, the industrial equipment must also be connected to the Internet.

Additionally, chatbot messaging processing should be nearly instantaneous. When using a messaging application, users have an expectation of immediate responses. Due to this expectation, it is important and desirable to have an instant communication channel to the industrial equipment from the Cloud (so that remote Fulfillment Actions can be processed instantly, in real time).

To achieve this requirement, the invention includes the aforementioned local computer 42. Local computer 42 is a piece of modern computing equipment that resides near the industrial equipment. Typically, local computer 42 may reside in the electronics cabinet where other power, electronics, and computers reside. The local computer has the following important characteristics for this invention. The local computer is connected to the Internet so that it can maintain a constant connection the cloud (for processing of Fulfillment Actions). The type of connection is not important, although it may be wired, wireless, or cellular. The local computer typically initiates a long-lived Transmission Control Protocol (TCP) connection to the cloud. This “outbound” connection is desirable for many corporate IT groups as an “inbound” connection has IT/Network security concerns. In practice, this connection typically masquerades an outbound, secure web connection. This type of connection is network friendly. It is important to note that this long-lived TCP connection is securely encrypted. In practice, this connection would be implemented using industry standard network security protocols such as Transport Layer Security (TLS).

The local computer is also connected to the Industrial Equipment's PLC 44 and/or sensors 46. The PLC is typically the computer that manages and runs the equipment. Having access to the PLC allows the local computer to read sensor data, configuration data, and to control the machine. Typically, access to the PLC would be performed over a serial connection or an Ethernet connection using an industry-standard protocol such as Modbus.

Relatedly, the local computer can perform other functions not directly related to processing chatbot messages. This includes continuous monitoring of the PLC, which may be useful for reporting and analytical data in the Cloud (and even some of this data may end up getting delivered via a chatbot).

F. Fulfillment Action Processing

The following are some of the steps of the process flow concerning the local computer and how it interacts with the PLC and the rest of the system.

1. When the local computer is powered on, it will make a connection to the PLC(s). 2. When the local computer is powered on, it will also make a secure connection over the Internet (using TCP) to the Cloud. 3. The local computer will send one or more unique identifiers, by which the local computer identifies, authenticates, and authorizes itself to the Cloud. 4. If the Cloud authenticates and authorizes in coming request, the request connection will remain open by the Cloud. If authentication or authorization fails, the connection will be instantly terminated. 5. When a Fulfillment Action for a remote piece of equipment is processed, the remote connection is located by the Cloud and the Fulfillment Action request (and its data parameters) are sent over the long-lived TCP connection to the local computer. 6. The local computer receives the Fulfillment Action request. If the local computer knowns how to handle the request (based on the installed software library of Fulfillment Actions), the local computer will process the request. This typically involves reading and writing data to and from memory addresses of the PLC. 7. The requested data is then sent back to the cloud over the long-lived TCP connection by the local computer.

### Detailed Workflow

The following sequence of events occurs when a user sends a message to an industrial machine (with reference again to FIG. 1). 1. The user types in a message or uses voice-to-text to send a voice message using a messaging application 10. 2. The messaging Chatbot Integration 12 intercepts the message and forwards it to the Chatbot Gateway 22, residing in The Cloud 20. 3. The Chatbot Gateway 22 queries the Authentication and Authorization service 24 to ensure that the user has access to the system. As shown in FIG. 1, Authentication and Authorization system 24 preferably resides in the cloud 20. 4. The Chatbot Gateway 22 looks to see if the user is currently in conversational context of a given piece of machinery (normally, this is done by saying: “Hello MACHINE NAME”, where every machine may be given a unique name). If the Chatbot Gateway 22 is unable to locate a conversational context, the Chatbot Gateway 22 may reply back to the user with a message that says something similar to: “I don't know which machine you are talking to”. 5. If there is a conversation context and a machine in that context, the Chatbot Gateway 22 will also query the Authentication and Authorization service 24 to ensure that the user is allowed to converse with this particular machine 40. 6. Assuming that the user has an appropriate level of access to the machine itself, the Chatbot Gateway 22 will send the text request to Natural Language Processing system 28 to deconstruct the semantic structure of the incoming request. 7. Once the request has been analyzed, the semantic structure will be parsed and mapped against a library of commands and queries. 8. If the command or query matches a conversation workflow that is backed by Rules Engine 30, then Rules Engine 30 will take over and start a new conversation based on a state diagram processed by the rules engine. Many troubleshooting workflows are typically backed and executed by Rules Engine 30. The chatbot system 8 gets the first response from the starting state of the Rules Engine 30. 9. If the command is not part of a rules engine workflow, the parsed command will be executed by the Chatbot Gateway 22. If the parsed command is a data request from the user (such as “show me upcoming service visits”, or “show me reported machine utilization”), then the system will use the Data API 32 to make a request from the cloud database, format the data, and send it back as a response. 10. If the request is a direct command or query from the live machine, a command will be directly issued to the Remote Control Service 36 to send a command to local computer 42. 11. Remote Control Service 36 sends the command to local computer 42 over the persistent network connection maintained between the local computer and the Remote Control Service 36. If this persistent command does not exist, the Chatbot Gateway 22 may reply back with a message to the user that the machine is not currently available. 12. The local computer 42 receives the command, and executes logic to read or write data to the Industrial Equipment's PLC 44. Once the command is completed, data is sent back to the remote control service over the persistent connection between the local computer and the Cloud's remote control service. The remote control service replies back to the Chatbot Gateway 22. The ChatBot Gateway 22 replies to the user in their chat messaging system 10.

### Example Chatbot Conversation #1

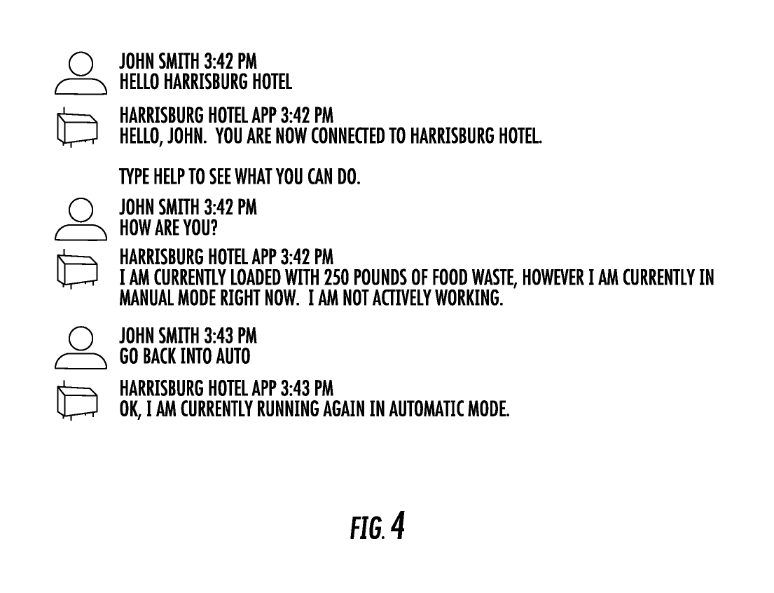

The following outline demonstrates a first possible interaction between a user and waste disposal machine. FIG. 4 is a depiction of what the user sees during this conversation. In this example, the user queries the status of the machine and instructs the machine to go from a “manual” operation mode to an “automatic” operation mode:
1. The user picks up his phone and launches a corporate messaging application, in this example, he is using “slack” (a popular chat/messaging application).
2. The user goes to a private “channel” where he can have a conversation with one of his waste disposal machines.
3. In this private channel, he types “hello harrisburg hotel” to have a conversation with a waste disposal machine that is located at the Harrisburg Hotel facility.
4. The chatbot system contacts the machine to see if it is online (connected to the Internet). In this case, the machine is online. The system replies with “Hello John, you are now connected to Harrisburg Hotel”.
5. The user types “how are you?” The chatbot system parses this incoming request and generates a command to the waste machine to query its system status. The chatbot replies with some key statistics from the machine. In this case, the machine lets the user know that the machine has 250 pounds of food waste in it, and that the machine is in a “manual” mode (which means, that the machine is not running)
6. The user types: “go back into auto”. The chatbot system parses the command and sends it to the waste machine. The waste machine starts operating again. The chatbot replies to the user that the system is now running again in automatic mode.

In this example, the user monitors the machine and controls the machine from their smart phone, using readily-available messaging software already used by their company (in this case, “slack”). He used a simple, natural conversation to understand the machine's status and change the machine's mode of operation. It is important to note that all of this was done without being anywhere near the machine. The user did not need to walk over to the machine, and access its operation panel (which may sometimes be under lock and key).

It is also important to note that this transaction was authenticated and authorized in the Cloud. All details of this conversation were fully audited (including the command to change the operation mode of the machine). Likewise, an organization could instantly limit or revoke this access electronically. Finally, this invention makes use of state-of-the-art security technology to ensure that the communication between the end-user and the machine cannot be eavesdropped upon or tampered with.

### Example Chatbot Conversation #2

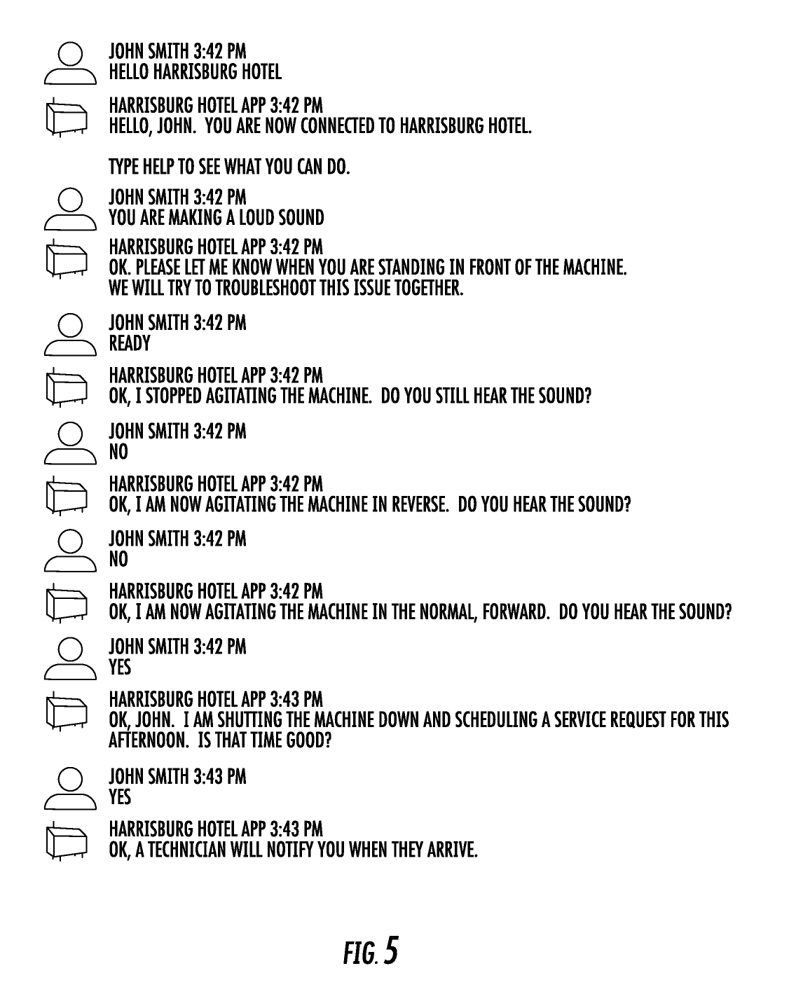

The following outline demonstrates a possible interaction between a user and waste disposal machine. FIG. 5 is a depiction of what the user sees during this conversation.

In this example, the machine has a problem—a loud “knocking” sound coming from the machine. The chatbot walks the user through a troubleshooting procedure.
1. The user picks up his phone and launches a chat application.
2. In this private channel, he types “hello harrisburg hotel” to have a conversation with a waste machine that is located at the Harrisburg Hotel facility.
3. The chatbot system contacts the waste machine to see if it is online and connected to the Internet. In this case, it is. The system replies with “Hello John, you are now connected to Harrisburg Hotel”.
4. The user types “you are making a loud sound.”
5. The chatbot system asks the user to stand directly in front of the machine. And to reply when the user is in front of the machine.
6. The user replies and types: “ready”.
7. The chatbot system pauses the agitation function on the Digester. The chatbot system replies and says: “do you still hear the sound?”.
8. The user replies and types: “no”.
9. The chatbot system moves the agitation function on the Digester in reverse. The chatbot system replies: “do you still hear the sound?”
10. The user replies and types: “no”.
11. The chatbot system asks the user to open the food hatch door and check for any debris inside of the machine, and to let the system know when she is ready.
12. The user replies and types: “done”.
13. The system continues with the forward agitation function on the Digester. The chatbot system replies: “do you still hear the sound?”.
14. The user replies and types: “yes”.
15. The chatbot system puts the machine into a “maintenance stop” mode and creates a service request for the machine (first confirming the time with the user), and notifies the user to stop using the machine and that a service representative will be at his location shortly.

In this scenario, the user launched a different application (a custom mobile app), which also has a messaging capability built into it. This simply illustrates that there can be different type of chat and messaging clients that can connect to the system outlined in this document. The invention is not limited to just one method of messaging.

The system uses a rules-based engine to walk the user through a specific workflow once it recognizes that there is a loud noise coming from the machine. While the machine is still broken at the end of this workflow, the system has able to immediately schedule a service call with detailed description of the issue and the troubleshooting which already took place.

### Example Message Flow Part I (User Greets a Machine)

Reference numerals refer to FIGS. 1 and 3.
1. A user opens his third-party messaging application 10 (in this example, “Slack”).
2. The user types the following message into his messaging client: “hello harrisburg hotel”.
3. The third-party messaging client delivers the message to Chatbot Gateway 22 in the Cloud 20 via the Slack Adapter 12.
4. The Adapter Translation service puts the message into a common internal message format and notes the sender of the message as john.smith@biohitech.com (from the “Slack” message's data payload).
5. Authentication Services 24 looks up the email address to ensure that the current message sender is a registered and trusted user in the system. Note: if the user is registered, but not trusted, a “challenge” response may be sent to the user (for example: to enter some type of password). Also note that such an authentication challenge may not be sent back using the same communication channel based on the security requirements of the system.
6. After successful authentication of the user, the message is routed to the Conversation/Natural Language Engine 28 for further processing.
7. The Conversation Engine 28 parses the request and extracts useful information about the request. In the case, the engine determines “Harrisburg Hotel” might be of interest later.
8. The Conversation Engine 28 uses the parsed request to match the incoming request against a dialog named “hello equipment”. This dialog is used to start a conversation with a given machine 40.
9. The Conversation Engine 28 authorizes access to the “hello equipment” dialog. In this example, the user is authorized to use this dialog.
10. The Conversation Engine 28 knows that the first step of the “hello equipment” dialog requires a parameter for the name or location of the equipment. The “Harrisburg Hotel” entity is formally mapped as a parameter for the equipment name for this request.
11. The Conversation Engine 28 communicates back to the Chatbot Gateway 22, requesting for a Fulfillment Action 38 for “search equipment”, with a parameter of “Harrisburg Hotel”.
12. The Chatbot Gateway 22 uses the Fulfillment Bridge to execute the request for searching a piece of equipment. Note that further authorization may be performed here. While all users may have the ability to “Say Hello” to a piece of equipment, not all users may be permitted to communicate with all equipment. In this case, the “search equipment” action looked up “Harrisburg Hotel” in a cloud database, where all equipment is registered and tracked. The equipment is successfully and uniquely identified, and the user is further verified (and authorized) to access this piece of equipment.
13. The Fulfillment Bridge receives this equipment information from the Fulfillment Action 38 and notifies the Conversation Engine 28 that the request was successful, and that the designated piece of equipment is now associated with the current conversation context (so that all future messages can be applied to the “Harrisburg Hotel” piece of equipment).
14. The Conversation Engine 28, using its dialog workflow, decides that a “Hello Response” should be generated back to the user. In this case, the Conversation Engine 28 constructs a response message saying: “Hello, John. You are now connected to Harrisburg Hotel.”
15. The Chat Gateway 22 sends the message to the appropriate messaging system 10, and the messaging system delivers the message recipient through the Message Adapter 12.

### Example Message Flow Part II (User Requests to Set the Temperature)

1. The user types the following message into his messaging client: “set the shell temperature warmer”.
2. The third-party messaging client 10 delivers the message to Chat Gateway 22 in the Cloud 20 via the Slack Adapter 12.
3. The Adapter Translation service puts the message into a common internal message format and notes the sender of the message as john.smith@biohitech.com (from slack message data payload).
4. Authentication Services 24 looks up to ensure that the current message sender is a registered and trusted user in the system. Note: if the user is registered, but not trusted, a “challenge” response may be sent to the user (for example: to enter some type of password). Also note that such an authentication challenge may not be sent back using the same communication channel based on the security requirements of the system.
5. After successful authentication of the user, the message is routed to the Conversation Engine 28 for further processing.
6. The Conversation Engine 28 parses the request and extracts useful information about the request. In the case, the engine has not detected entities of interest.
7. The Conversation Engine 28 uses the parsed request to match the incoming request against a dialog named “set shell temperature”. This dialog is used to set a new target “shell temperature” for the machine (this may be a common operational activity performed by operators of the machine).
8. The Conversation Engine 28 authorizes access to the “set shell temperature” dialog. In this example, the user is authorized to use this dialog. In this example, only “machine managers” can perform this activity, so the system may employ a level of roles-based access to this dialog.
9. The Conversation Engine 28 knows that the first step of the “set shell temperature” dialog requires a parameter for the desired target temperature. The system does not have the required entity for this parameter, so the conversation engine “pauses the current dialog”, and generates a response back to the user: “What temperature would you like the temperature to be?”
10. The Chat Gateway 22 sends the message to the appropriate messaging system 10, and the messaging system delivers the message recipient through the Message Adapter 12.
   Example Message Flow Part III (User Replies with the Temperature)
1. After receiving the response “What temperature would you like the temperature to be?” the user replies with the message “40 degrees”.
2. The third-party messaging client 10 delivers the message to Chatbot Gateway 22 in the Cloud 20 via the Slack Adapter 12.
3. The Adapter Translation service puts the message into a common internal message format and notes the sender of the message as john.smith@biohitech.com (from slack message data payload).
4. Authentication Services 24 looks up to ensure that the current message sender is a registered and trusted user in the system.
5. After successful authentication of the user, the message is routed to the Conversation Engine 28 for further processing.
6. The Conversation Engine 28 parses the request and extracts useful information about the request. In the case, the engine determines “40 degrees” might be of interest later.
7. The Conversation Engine 28 knows that the current conversational dialog is the “set shell temperature dialog” and resumes the “paused” conversation at its current state (where a missing parameter was not supplied last time).
8. The Conversation Engine 28 authorizes access to the “set shell temperature” dialog. In this example, the user is authorized to use this dialog.
9. The Conversation Engine 28 knows that the value of “40” (and its unit “degrees”) is a parameter to the “set shell temperature” dialog.
10. The Conversation Engine 28 communicates back to the Chatbot Gateway 22, requesting for a Fulfillment Action 38 for “set shell temperature”, with a parameter of “40” for the “Harrisburg Hotel” machine (which was established with the first message in the conversation).
11. The Chatbot Gateway 22 uses the Fulfillment Bridge to execute the request for setting the new shell temperature. The system infers that the user normally works in metric units, so the request for “40” is interpreted as 40 degrees Celsius (as opposed to Fahrenheit). The Fulfillment Action also authorizes in the incoming request.
12. The “Set Shell Temperature” fulfillment action sends a message to the Harrisburg Hotel's equipment's Local Computer 42. This message is sent using the long-lived, outbound TCP connection that the Local Computer 42 initiates with the Cloud.
13. The Local Computer 42 receives the request for setting the shell temperature to 40° Celsius and instructs the equipment's PLC 44 to set the shell temperature to 40° C. Typically, this is performed using an industry-standard protocol such as Modbus to communicate with the PLC and write commands and data to memory locations inside of the PLC system.
14. The Local Computer 42 replies to the Cloud that the request was successfully processed. This response is sent over the long-lived, outbound TCP connection that the Local Computer 42 initiates with the Cloud.
15. The Chatbot Gateway 22 notifies the Conversation Engine 28 that the action was successfully completed by the Fulfillment Action 38.
16. The Conversation Engine 28 generates a text response, saying: “OK, the shell temperature has been set to 40° C.”
17. The Chatbot Gateway 22 sends the message to the appropriate messaging system 10 and recipient through the Message Adapter 12.
18. The user receives the message on their message application.

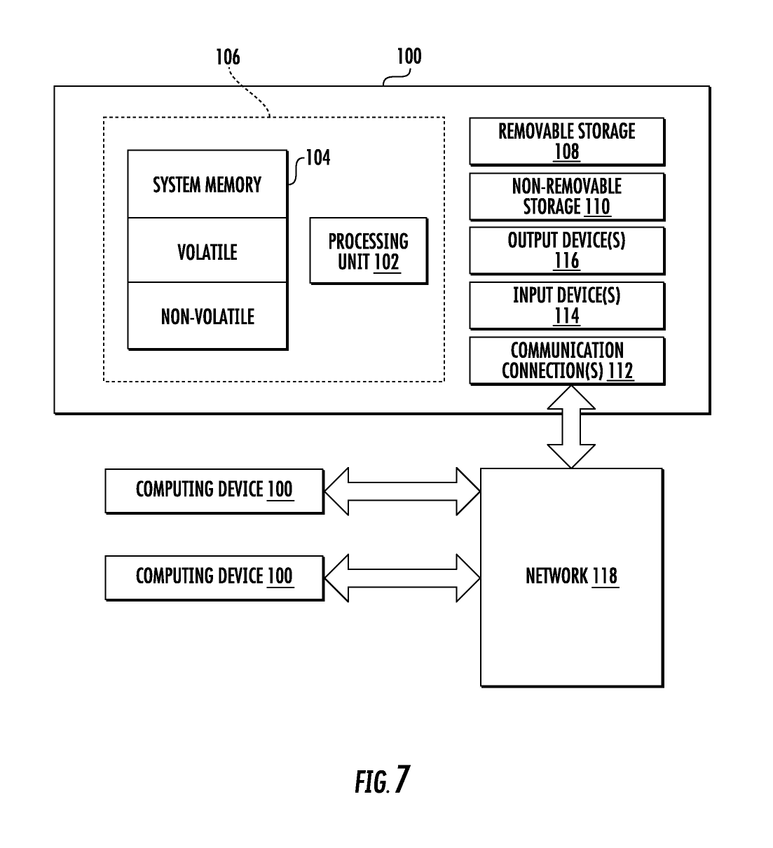

FIG. 7 depicts an exemplary computing environment in which various embodiments of the invention may be implemented. The computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal electronic devices such as smart phones and smart watches, tablet computers, personal computers (PCs), server computers, handheld or laptop devices, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 7 by dashed line 106. Computing device 100 may have additional features/functionality. For example, computing device 100 may include additional storage (removable and/or non-removable) including, but not limited to, magnetic or optical disks or tape. Such additional storage is illustrated in FIG. 7 by removable storage 108 and non-removable storage 110.

Computing device 100 typically includes or is provided with a variety of computer-readable media. Computer-readable media can be any available media that can be accessed by computing device 100 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 104, removable storage 108, and non-removable storage 110 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 100. Any such computer storage media may be part of computing device 100.

Computing device 100 may also contain communications connection(s) 112 that allow the device to communicate with other devices. Each such communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. The term computer-readable media as used herein includes both storage media and communication media.

Computing device 100 may also have input device(s) 114 such as keyboard, mouse, pen, voice input device, touch input device, etc. Output device(s) 116 such as a display, speakers, printer, etc. may also be included. All these devices are generally known and therefore need not be discussed in any detail herein except as provided.

Notably, computing device 100 may be one of a plurality of computing devices 100 inter-connected by a network 118, as is shown in FIG. 7. As may be appreciated, the network 118 may be any appropriate network; each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the internet or the like.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as USB flash drives, SD cards, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural, functional, or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effected across a plurality of devices in a network 118. Such devices might include personal computers, network servers, and handheld devices, for example.

A significant advantage of the invention is that much of the “intelligence” resides in the cloud, which is easily updatable (from a software updates/upgrade standpoint). So if the “user interface” to the machine is the chatbot, one can effectively update the user's “user interface” very rapidly in the cloud, providing new tools, features, and diagnostic capabilities. This can be contrasted with today where you would need to upgrade the software on the PLC and touchscreen to get a similar benefit (but this requires an on-site visit) and may also require extensive scheduling and planning as the machine equipment may be down during the upgrade (which is decidedly not ideal).

Having described certain embodiments of the invention, it should be understood that the invention is not limited to the above description or the attached exemplary drawings. Rather, the scope of the invention is defined by the claims appearing hereinbelow and includes any equivalents thereof as would be appreciated by one of ordinary skill in the art.

What is claimed is:

1. A system for remotely communicating with and controlling industrial machinery, comprising:
at least one piece of industrial machinery, said piece of industrial machinery having:
at least one sensor for monitoring at least one condition of said piece of industrial machinery; and
a programmable logic controller (PLC) directly controlling operation of said piece of industrial machinery and in communication with said sensor;
a local computer in communication with said PLC adapted to query and write data from and to said PLC; and
a remotely accessible chatbot interface in communication with said local computer, adapted to enable natural language interaction between a user and said piece of industrial machinery,
wherein a user accesses said chatbot interface on a remote device adapted to communicate with said local computer.

2. A system for remotely communicating with and controlling industrial machinery in accordance with claim 1, wherein at least a portion of said chatbot interface resides in a cloud computing environment.

3. A system for remotely communicating with and controlling industrial machinery in accordance with claim 1, said chatbot interface further comprising:
a user interface, accessible from the remote device, adapted to receive and send natural language messages to and from a user; and
a chatbot gateway that authenticates incoming messages from the user.

4. A method of remotely communicating with and controlling industrial machinery via a chatbot interface, comprising the steps of:
sending a text-based message via a messaging application to a chatbot gateway;
sending the text request from the chatbot gateway to a natural language processing system;
deconstructing the semantic structure of the incoming request at the natural language processing system;
parsing and mapping the semantic structure against a library of commands and queries;
sending a command or query that correlates to the parsed and mapped incoming request to a local computer via a persistent network connection; and
executing logic at the local computer to read or write data to the industrial equipment's PLC.

5. A method of remotely communicating with and controlling industrial machinery via a chatbot interface according to claim 4, wherein said logic executing step causes a command to be issued to the industrial machinery.

6. A method of remotely communicating with and controlling industrial machinery via a chatbot interface according to claim 5, further comprising the step of, once the command is completed, sending data back to the user from the local computer via the chatbot gateway to the user in their messaging application.

7. A method of remotely communicating with and controlling industrial machinery via a chatbot interface according to claim 4, wherein the chatbot gateway and the natural language processing system are cloud-based.

8. A method of remotely communicating with and controlling industrial machinery via a chatbot interface according to claim 4, wherein the messaging application is accessible by the user from a remote device.
